(19) United States
(12) Patent Application Publication
(10) Pub. No.: US 2024/0337112 A1
(43) Pub. Date: Oct. 10, 2024

(54) FLOORING WITH EMBOSSED CORE THAT IS DIRECTLY PRINTED

(71) Applicant: ENGINEERED FLOORS, LLC, Dalton, GA (US)

(72) Inventor: Daniel Green, Ringgold, GA (US)

(73) Assignee: ENGINEERED FLOORS, LLC, Dalton, GA (US)

(21) Appl. No.: 18/631,268

(22) Filed: Apr. 10, 2024

Related U.S. Application Data
(60) Provisional application No. 63/495,179, filed on Apr. 10, 2023.

(51) Int. Cl. E04F 15/10; B29C 48/00; B29L 31/00

(52) U.S. Cl. CPC E04F 15/107; B29C 48/002; B29C 48/0023; B29L 2031/732

(57) ABSTRACT

Flooring and sheet material having an extruded core that is mechanically embossed and directly printed with a desired décor image. One or more scratch resistant and UV resistant coatings can be applied thereafter. In one example, the embossing is performed directly after the core is extruded and cooling down, releasing heat generated during the extrusion thereof. An embossed roller, an embossed press plate or the like can be provided to permanently impress an emboss pattern in the core.

### CROSS-REFERENCE TO RELATED APPLICATION

This application claims priority to U.S. Provisional Patent Application Ser. No. 63/495,179 filed Apr. 10, 2023 which is incorporated herein by reference.

### TECHNICAL FIELD

The present invention relates generally to the field of flooring and methods of manufacturing flooring, and more particularly to flooring materials or components having an mechanically embossing a core that is directly printed on for flooring.

### BACKGROUND

One well known type of commercial and residential flooring is commonly referred to as stone plastic (or polymer) composite (SPC) flooring. With reference to FIGS. 1 and 2, traditional SPC flooring 1 is known for being a rigid vinyl flooring comprising a core 2 that is made by combining natural limestone powder, PVC resin, and stabilizers in a high-speed mixer to form a homogenous mixture, feeding the mixture to an extruder, which melts the mixture and forms it into a sheet. The extruded sheet is then cooled down using a calendaring machine. As depicted in FIGS. 1-2, traditional SPC flooring 1 most commonly includes the following materials/layers such as the core 2, a décor film layer 3, an embossed PVC wear layer 4 for scratch resistance and texture, and a top layer 5 for UV resistance. While the flooring is durable and desirable among the flooring community, SPC flooring maintains a relatively high cost due to the quantity of raw materials and reliance upon imported décor films. Continuous improvements for flooring are sought. It is to the provision of a mechanically embossed core that is directly printed for flooring meeting these and other needs that the present invention is primarily directed.

### SUMMARY

In example embodiments, the present invention provides an embossed core that is directly printed for flooring. In example embodiments, the core is mechanically embossed with a roll-type embossing device (e.g., an embossed roller) while the core is extruded and still warm from its extrusion, the embossing thereby remaining permanent with the core. In some example embodiments, a press plate or the like can be provided for embossing the core instead of an embossed roller. Thereafter, the embossed core is presented to a digital printer for printing a décor layer thereon, followed by roll coaters for the application of a scratch resistant and UV protection layer. The décor layer can be configured to depict or resemble a particular flooring style, configuration or format and can align with the embossed features of the core.

In one aspect, the present invention relates to a mechanically embossed core directly printed for flooring. The core is configured to be embossed by an embossed roller, press plate or the like after the core is extruded, thereby forming a permanent embossed feature in the core. Thereafter, a printer is configured to print a desired décor layer thereon. Roll coaters are then provided for the application of resistant layers for scratch resistance and UV resistance.

In another aspect, the invention relates to a method of manufacturing flooring comprising extruding a core, embossing the extruded core, printing on the embossed core, applying a scratch resistance layer atop the printed layer, and applying a UV resistant layer atop the scratch resistance layer. In example embodiments, the core is embossed directly after extrusion with an embossed roller, a press plate or the like. In example embodiments, the embossing is performed while the core is still warm from the extrusion process, thereby ensuring permanent embossing thereon.

In example embodiments, the core is mechanically embossed directly after the extrusion thereof with an embossed roller or a press plate. In example embodiments, the embossing is performed while the core is still warm from the extrusion process, thereby ensuring the embossing makes a permanent impression in the core. In example embodiments, the scratch resistance layer comprises aluminum oxide. In example embodiments, the UV resistance layer comprises polyurethane combined with one or more UV stabilizers.

In still another aspect, the invention relates to a mechanically embossed extruded sheet material directly printed on applying a décor layer. One or more protective coatings can be applied atop the décor layer. The sheet material is further processed, cutting to a desired width and length to form interconnectable floor segments.

In still another aspect, the invention relates to a flooring component including a core formed from a combination of polyvinylchloride, calcium carbonate and process aids. In example embodiments, the core is presented to an embossing device after the manufacture thereof such that the core comprises an embossed pattern permanently formed in the core. In example embodiments, a décor image is directly printed on the embossed core. In example embodiments, at least one coat of aluminum oxide layer can be applied atop the printed décor image. In example embodiments, at least one coat of a UV resistant layer can be applied atop the aluminum oxide layer.

In example embodiments, the embossing device includes an embossed roller configured to press against the core after the extrusion thereof and permanently impress the embossed pattern in the core. In example embodiments, the embossing device comprises a press plate for permanently impressing the embossed pattern in the core. In example embodiments, a digital printer is configured to directly print the décor image on the embossed core. In example embodiments, the digital printer can be configured to align the décor image directly printed thereon with the embossed pattern.

In example embodiments, a roll coater is provided for the application of each of the coats applied atop the printed décor image. In example embodiments, the core is mechanically embossed directly after its extrusion. In example embodiments, the core has a temperature that is at least greater that the ambient room temperature when being mechanically embossed.

In yet another aspect, the present invention relates to a mechanically embossed core that is directly printed for flooring. In example embodiments, the core includes an extruded sheet including a combination of polyvinylchloride, calcium carbonate and process aids, wherein directly after the extrusion thereof and while the extruded sheet has a temperature above the ambient room temperature, at least one surface of the core is mechanically embossed such that an embossed pattern is permanently impressed in the core.

In example embodiments, an embossed roller is configured to roll against and apply pressure to the core so as to permanently impress the embossed pattern in the core. In example embodiments, an embossed press plate is configured to press against and apply pressure to the core so as to permanently impress the embossed pattern in the core. In example embodiments, the embossed core can be directly printed on. In example embodiments, a digital printer is provided for directly printing the décor image on the embossed core. In example embodiments, the digital printer can be configured to match and/or align the embossed pattern with the décor image. In example embodiments, at least one coat of an aluminum oxide layer and at least one coat of a UV resistant layer can be applied to the core.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective assembly view of traditional prior art flooring construction.

FIG. 2 is a detailed perspective view of the traditional prior art flooring construction of FIG. 1.

FIG. 3 is a perspective assembly view of a flooring segment having a pre-embossed core according to an example embodiment of the present invention.

FIG. 4 is a detailed perspective view of the flooring segment having a pre-embossed core of FIG. 3.

FIG. 5A shows a top perspective view of a finished flooring segment having an embossed core that is directly printed according to an example embodiment of the present invention.

FIG. 5B shows a detailed edge cross-sectional view of the flooring component of FIG. 5A.

FIG. 6A shows a top perspective view of an embossed core in sheet form.

FIG. 6B shows a detailed cross-sectional view of the flooring sheet of FIG. 6A.

FIG. 7 is a flow diagram of a flooring manufacturing process according to an example embodiment of the present invention.

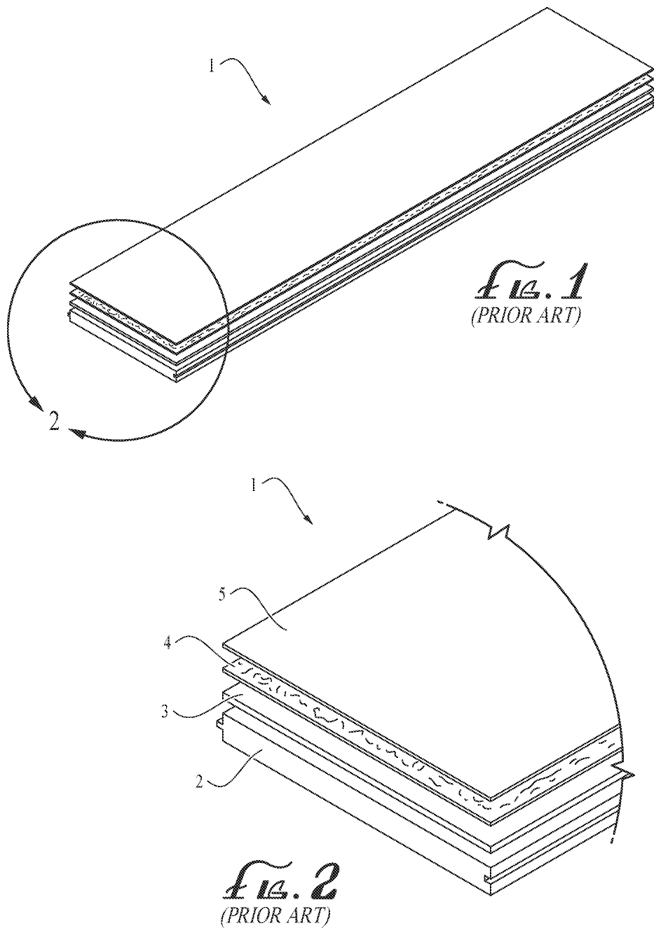

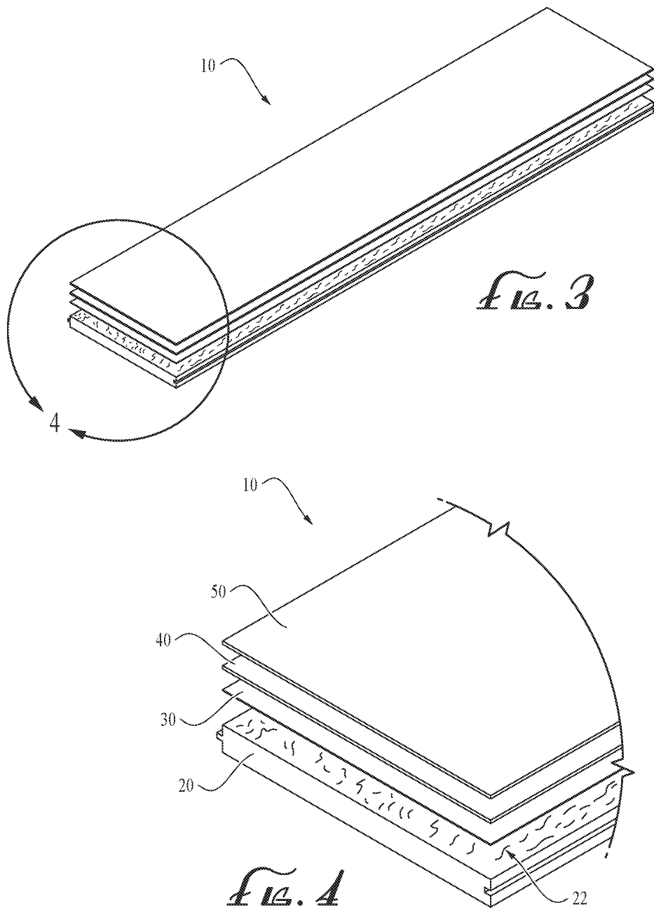

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

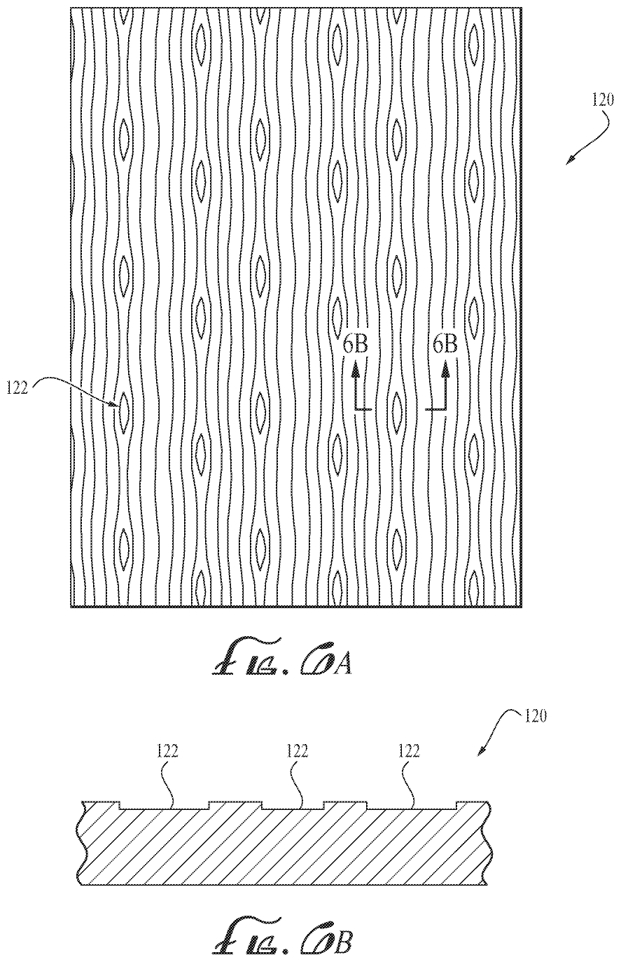

With reference now to the drawing figures, wherein like reference numbers represent corresponding parts throughout the several views, FIGS. 3-5 show a flooring component 10 according to an example embodiment of the present invention. According to example embodiments, the flooring component 10 comprises a mechanically embossed core 20 that comprises an embossed pattern or impressions 22 permanently formed with the core 20, for example on or in a top or upper surface thereof. In example embodiments, the embossed core 20 is first extruded to form a desired shape, and then an embossing device can be provided to permanently emboss at least one surface of the extruded core. Said another way, at least one surface of the extruded core can be mechanically embossed such that an embossed pattern is permanently impressed in the core. In example embodiments, the embossing device can be in the form of an embossed roller that can roll against a surface of the core (while applying heat and/or pressure thereto) so as to transfer the embossed pattern of the roller to the core 20. In example embodiments, the core is embossed when its internal temperature is greater than the ambient room temperature. For example, according to one example embodiment, the core 20 is mechanically embossed immediately after it is extruded and while it continues to release heat from the extrusion process, thereby ensuring the embossed pattern remains permanent with the core. According to other example embodiments, the core may be mechanically embossed by an embossed press plate or various other embossing/impression devices.

According to example embodiments, the embossed pattern is intended to replicate a natural wood surface and appearance, for example, in combination with an image that is directly printed thereon (as described below). For example, according to example embodiments, the embossed surface of the roller or plate comprises a plurality of indentions and/or raised projections that cause the formation of recessed portions or impressions 22 within the core that match the raised projections of the roller or plate, thereby leaving the core 20 with the embossed pattern permanently impressed in the core. According to some example embodiments, the surface comprising the embossed pattern can comprise other surface irregularities and imperfections throughout its surface, not just a pattern of raised projections, for example to preferably closely resemble a natural appearance, such as for example a natural woodgrain or stone pattern.

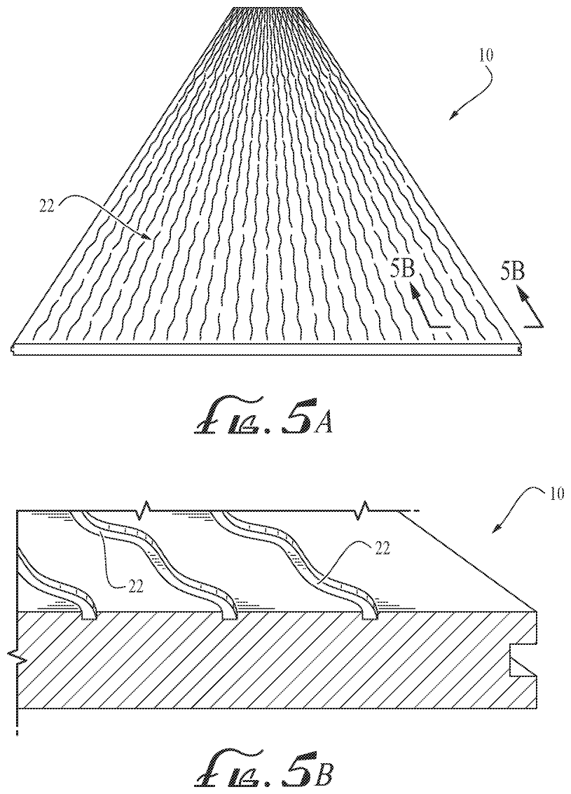

According to example embodiments, the embossed core 20 is configured for direct printing thereon. According to example embodiments, a digital printer can print a décor image or pattern 30 directly on the embossed core. In example embodiments, the direct printing is applied at least to the surface comprising the embossed pattern that is permanently impressed in the core 20. Although depicted separately in the exploded view of FIG. 4 for clarity of understanding, in example forms the décor image or pattern 30 is formed by application directly onto the surface of the embossed core 20. According to example embodiments, the digital printer can be configured so as to detect the embossed pattern in the core, and thus align the décor image with the embossing to provide an improved visual and realistic appearance. According to example embodiments, the printed décor image 30 comprises a natural wood appearance, and for example can comprise one or more characteristics that match one or more impressions of the embossed pattern. Optionally, the décor image 30 can be chosen as desired.

According to example embodiments, a scratch resistant layer 40 and a UV resistant layer 50 are applied to the printed décor image 30. In example embodiments, the scratch resistant layer 40 comprises aluminum oxide and the UV resistant layer 50 comprises a mixture of polyurethane and UV stabilizers. Optionally, other materials can be used as desired for both the scratch resistant layer 40 and the UV resistant layer 50. Optionally, the flooring 10 can comprise more than one application of the layers 40, 50 atop the printed embossed core.

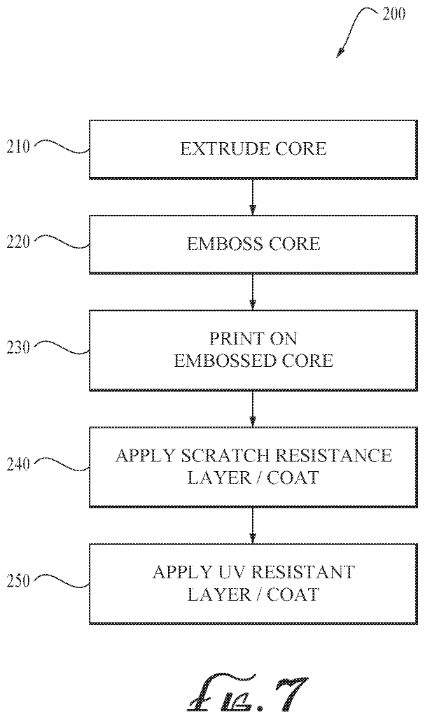

In example embodiments, the core is extruded and mechanically embossed while remaining in sheet form, but in other embodiments may be extruded, mechanically embossed, printed and coated in piece form. For example, as depicted in FIG. 6 (i.e., FIGS. 6A and 6B collectively), the embossed core 120 is in sheet form (for example 4′×8′ or 5′×10′ according to some examples) and comprises an embossed pattern having a plurality of impressions 122 formed with an upper surface of the core sheet. Accordingly, the embossed roller (or press plate) can be configured to have a dimension large enough to span the entirety of the length and/or width of the sheet.

According to another example embodiment and as depicted in FIG. 7, the present invention further relates to a method of manufacturing flooring 200 comprising extruding a core 210, embossing the extruded core 220, printing on the embossed core 230, applying a scratch resistance layer atop the printed layer 240, and applying a UV resistant layer atop the scratch resistance layer 250. In example embodiments, the core is embossed directly after extrusion with an embossed roller, a press plate or the like. In example embodiments, the embossing is performed while the core is still warm from the extrusion process, thereby ensuring permanent embossing thereon. In example embodiments, the scratch resistant layer 250 comprises aluminum oxide and the UV resistance layer 250 comprises polyurethane combined with one or more UV stabilizers.

According to example embodiments, during the processing and manufacture of the flooring as disclosed herein, one or more pillowed or eased edges may be formed in the flooring segments. For example, when cutting a finished sheet of the flooring of the present invention into individual flooring pieces or segments, a pillowed edge or eased edge may be formed along one or more portions thereof. In example embodiments, the pillowed or eased edge comprises at least some amount of a non-linear surface formed therealong, not to be confused with a beveled edge that is merely a chamfer or angled surface. According to example embodiments, if it is necessary to cover the edge that was formed during the processing and manufacture thereof, the embossed core may be cut into individual flooring segments and their edges shaped prior to direct printing, for example, to simplify the manufacturing process. As such, a jig or other carousel may be configured to retain a plurality of flooring segments to maximize the printing efficiency when printing embossed core flooring segments rather than printing an embossed core in sheet form.

While the invention has been described with reference to example embodiments, it will be understood by those skilled in the art that a variety of modifications, additions and deletions are within the scope of the invention, as defined by the following claims.

What is claimed is:

1. A flooring component comprising:
a core comprising an embossed pattern permanently formed in a surface of the core; and
a décor image directly printed onto the embossed core.

2. The flooring component of claim 1, wherein the embossed pattern is formed by an embossing device selected from an embossed roller and a press plate, the embossing device being pressed against the core to permanently impress the embossed pattern into the surface of the core.

3. The flooring component of claim 1, wherein the décor image is digitally printed directly onto the embossed surface of the core.

4. The flooring component of claim 3, wherein the décor image is aligned with the embossed pattern.

5. The flooring component of claim 1, wherein the core is mechanically embossed directly after its extrusion.

6. The flooring component of claim 1, wherein the core is mechanically embossed while the core is at a temperature greater than the ambient temperature.

7. The flooring component of claim 1, wherein the core comprises one or more materials selected from a polyvinylchloride, a calcium carbonate, one or more process aids, and/or a combination thereof.

8. The flooring component of claim 1, further comprising at least one layer of aluminum oxide applied over the décor image.

9. The flooring component of claim 8, further comprising at least one layer of a UV resistant material applied over the aluminum oxide layer.

10. The flooring component of claim 9, wherein at least one of the aluminum oxide layer and the UV resistant layer are applied thereon with a roll coater.

11. A mechanically embossed core for flooring that is configured for printing directly thereon, the core comprising an extruded panel, and wherein directly after the extrusion thereof and while the extruded panel is at a temperature above the ambient room temperature, at least one surface of the core is mechanically embossed whereby an embossed pattern is permanently impressed in the core.

12. The mechanically embossed core of claim 11, wherein the core comprises one or more materials selected from a polyvinylchloride, a calcium carbonate, one or more process aids, and/or a combination thereof.

13. The mechanically embossed core of claim 11, further comprising a décor pattern directly printed onto the embossed core.

14. The mechanically embossed core of claim 13, wherein the décor pattern is digitally printed directly onto the embossed core.

15. The mechanically embossed core of claim 14, wherein the décor pattern is configured to match and/or align with the embossed pattern.

16. The mechanically embossed core of claim 13, further comprising at least one layer of aluminum oxide applied over the décor pattern.

17. The flooring component of claim 16, further comprising at least one layer of a UV resistant material applied over the aluminum oxide layer.

18. The mechanically embossed core of claim 11, wherein the embossed pattern is formed by an embossing device selected from an embossed roller and a press plate, the embossing device being pressed against the core to permanently impress the embossed pattern into the surface of the core.

19. A method of manufacturing flooring comprising:
extruding a core;
embossing the extruded core to form an embossed pattern permanently impressed into a surface of the core; and
printing a décor pattern directly onto the embossed surface of the core.

20. The method of claim 19, wherein the core is mechanically embossed directly after the extrusion thereof with an embossed roller or a press plate.

21. The method of claim 20, wherein the embossing is performed while the core is still heated from the extrusion process, thereby ensuring the embossing makes a permanent impression in the core.

22. The method of claim 19, further comprising applying at least one of a scratch resistant layer and/or a UV resistant layer over the décor pattern.

23. The method of claim 22, wherein the scratch resistant layer comprises aluminum oxide.

24. The method of claim 22, wherein the UV resistant layer comprises polyurethane combined with a UV stabilizer.
